(19) United States
(12) Patent Application Publication
(10) Pub. No.: US 2026/0319189 A1
(43) Pub. Date: Oct. 15, 2026

(54) OPTICAL CONNECTOR

(71) Applicants: Sumitomo Electric Optifrontier Co., Ltd., Yokohama-shi, Kanagawa (JP); SUMITOMO ELECTRIC INDUSTRIES, LTD., Osaka-shi, Osaka (JP)

(72) Inventors: Masahiro SHIBATA, Kanagawa (JP); Takayuki SHIMAZU, Osaka (JP)

(73) Assignees: Sumitomo Electric Optifrontier Co., Ltd., Yokohama-shi, Kanagawa (JP); SUMITOMO ELECTRIC INDUSTRIES, LTD., Osaka-shi, Osaka (JP)

(21) Appl. No.: 19/491,476

(22) PCT Filed: Jul. 5, 2024
(86) PCT No.: PCT/JP2024/024497

§ 371 Date: Dec. 9, 2025

(30) Foreign Application Priority Data
Jul. 18, 2023 (JP) 2023-116900

(51) Int. Cl. G02B 6/40; G02B 6/38

(52) U.S. Cl. CPC G02B 6/403; G02B 6/3825; G02B 6/3854; G02B 6/3869; G02B 6/389

(57) ABSTRACT

An optical connector, comprising: a plurality of optical fibers extending rearward along a first direction; a ferrule that holds front end portions of the plurality of optical fibers; a housing that is provided on an outer periphery of the plurality of optical fibers and that accommodates portions of the plurality of optical fibers, the portions extending from the ferrule; and an elastic body that biases the ferrule forward along the first direction and that is accommodated in the housing. The ferrule has a front end surface facing a mating ferrule, a rear end surface facing away from the front end surface, and a first main surface and a second main surface that intersect a second direction, which is a thickness direction of the ferrule, while facing away from each other with the plurality of optical fibers interposed between the first main surface and the second main surface.

### TECHNICAL FIELD

The present disclosure relates to an optical connector. Priority is claimed on Japanese Patent Application No. 2023-116900, filed on Jul. 18, 2023, the entire content of which is incorporated herein by reference.

### BACKGROUND ART

Patent Literature 1 discloses a technology related to an interconnection system including a plurality of fiber cables for optical connection and a method for wiring the fiber cables. This system includes a connector housing that accommodates an optical connector in an optical adapter, and a ferrule provided in the optical connector. The ferrule is provided at a termination portion of one or a plurality of optical fibers. The optical connector is formed by the connector housing, and the optical connector is attached inside the optical adapter.

### CITATION LIST

### Patent Literature

Patent Literature 1: U.S. Pat. No. 11,474,307 Specification

Patent Literature 2: United States Patent Application, Publication No. 2019-0187383 Specification

Patent Literature 3: United States Patent Application, Publication No. 2023-0003949 Specification

### SUMMARY OF INVENTION

An optical connector according to one embodiment of the present disclosure includes a plurality of optical fibers extending rearward along a first direction; a ferrule that holds front end portions of the plurality of optical fibers; a housing that is provided on an outer periphery of the plurality of optical fibers and that accommodates portions of the plurality of optical fibers, the portions extending from the ferrule; and an elastic body that biases the ferrule forward along the first direction and that is accommodated in the housing. The ferrule has a front end surface facing a mating ferrule, a rear end surface facing away from the front end surface, and a first main surface and a second main surface that intersect a second direction, which is a thickness direction of the ferrule, while facing away from each other with the plurality of optical fibers interposed between the first main surface and the second main surface, and that connect the front end surface and the rear end surface. The housing includes a locking portion including a first latch that locks onto an optical adapter to fix the optical connector to the optical adapter, a lever portion that includes a first release portion that releases the locking of the first latch and a first limiting portion that engages with the ferrule on the first main surface to limit a movement of the ferrule based on a biasing force of the elastic body, and that is movable rearward relative to the locking portion, and a grip portion that is provided at a rear of the ferrule and that is connected to the lever portion to be movable rearward relative to the locking portion. The first latch is provided on the first main surface. The first release portion moves the first latch in a release direction in conjunction with the rearward movement of the grip portion. A member constituting the first release portion is common to a member constituting the first limiting portion.

### BRIEF DESCRIPTION OF DRAWINGS

FIG. 1 is a perspective view showing an optical connector according to a first embodiment of the present disclosure.

FIG. 2 is a side view showing the optical connector according to the first embodiment of the present disclosure.

FIG. 3 is a perspective view showing a ferrule.

FIG. 4 is a side view showing the optical connector and an optical adapter.

FIG. 5 is a perspective view showing a locking portion.

FIG. 6 is a perspective view showing a grip portion.

FIG. 7 is a perspective view showing a lever portion.

FIG. 8 is a front view of the optical connector when viewed in an x-direction.

FIG. 9 is a perspective view showing an optical connector according to a first modification.

FIG. 10 is a side view showing the optical connector according to the first modification.

FIG. 11 is a front view of the optical connector when viewed in the x-direction.

### DESCRIPTION OF EMBODIMENTS

### Technical Problem

An optical connector including a ferrule that holds a plurality of optical fibers may be accommodated, for example, in a protective tube having a cylindrical shape that is attached to the tip of an optical cable. For the sake of miniaturization, in recent years, the inner diameter of the protective tube has become smaller. When the width of the optical connector does not have sufficient clearance for the inner diameter of the protective tube, it is difficult to accommodate the optical connector in the protective tube. Reducing the width of the optical connector and miniaturizing the optical connector present a challenge.

### Advantageous Effects of Present Disclosure

According to the present disclosure, it is possible to provide an optical connector that can be miniaturized by reducing the width of the cross-section.

### Description of Embodiment of Present Disclosure

First, the contents of an embodiment of the present disclosure will be listed and described.
[1] An optical connector according to one embodiment of the present disclosure includes a plurality of optical fibers extending rearward along a first direction; a ferrule that holds front end portions of the plurality of optical fibers; a housing that is provided on an outer periphery of the plurality of optical fibers and that accommodates portions of the plurality of optical fibers, the portions extending from the ferrule; and an elastic body that biases the ferrule forward along the first direction and that is accommodated in the housing. The ferrule has a front end surface facing a mating ferrule, a rear end surface facing away from the front end surface, and a first main surface and a second main surface that intersect a second direction, which is a thickness direction of the ferrule, while facing away from each other with the plurality of optical fibers interposed between the first main surface and the second main surface, and that connect the front end surface and the rear end surface. The housing includes a locking portion including a first latch that locks onto an optical adapter to fix the optical connector to the optical adapter, a lever portion that includes a first release portion that releases locking of the first latch and a first limiting portion that engages with the ferrule on the first main surface to limit a movement of the ferrule based on a biasing force of the elastic body, and that is movable rearward relative to the locking portion, and a grip portion that is provided at a rear of the ferrule and that is connected to the lever portion to be movable rearward relative to the locking portion. The first latch is provided on the first main surface. The first release portion moves the first latch in a release direction in conjunction with the rearward movement of the grip portion. A member constituting the first release portion is common to a member constituting the first limiting portion.

In the optical connector according to [1] above, the first limiting portion and the first release portion are provided in the lever portion, and are formed from the common member. That is, the lever portion serves as the mechanism for both the first limiting portion and the first release portion. Accordingly, the first limiting portion and the first release portion can be miniaturized, so that the first limiting portion and the first release portion can be provided on the first main surface of the ferrule in a limited manner. Then, in addition to the first limiting portion and the first release portion, the first latch is also provided on the first main surface. The fact that the first limiting portion, the first release portion, and the first latch are provided on the first main surface means that the first limiting portion, the first release portion, and the first latch are disposed in the second direction that is not a maximum width direction of the ferrule. In a typical optical connector, at least a part of each of the side surfaces of the ferrule in a width direction is covered by the housing. Therefore, portions of the housing that cover the side surfaces define a maximum width of the optical connector, and the maximum width of the optical connector is greater than a maximum width of the ferrule. In contrast, in the optical connector according to [1] above, since the first limiting portion, the first release portion, and the first latch are provided on the first main surface in a limited manner, the expansion of the housing in the maximum width direction of the ferrule can be suppressed, and the width of the optical connector can be reduced. Therefore, the optical connector can be miniaturized.
[2] In the optical connector according to [1] above, the locking portion may further include a second latch that locks onto the optical adapter to fix the optical connector to the optical adapter. The second latch may be provided on the second main surface. The lever portion may further include a second release portion that moves the second latch in the release direction in conjunction with the rearward movement of the grip portion to release the locking between the second latch and the optical adapter, and a second limiting portion that engages with the ferrule on the second main surface to limit the movement of the ferrule based on the biasing force of the elastic body. A member constituting the second release portion may be common to a member constituting the second limiting portion. In the optical connector, the second limiting portion and the second release portion are provided in the lever portion, and are formed from the common member. That is, the lever portion serves as the mechanism for both the second limiting portion and the second release portion. Accordingly, the second limiting portion and the second release portion can be miniaturized, so that the second limiting portion and the second release portion can be provided on the second main surface of the ferrule in a limited manner. Then, in addition to the second limiting portion and the second release portion, the second latch is also provided on the second main surface. Therefore, the expansion of the housing in the maximum width direction of the ferrule can be suppressed, and the width of the optical connector can be reduced. Therefore, the optical connector can be miniaturized.
[3] In the optical connector according to [1] or [2] above, the lever portion may include a plate-shaped portion extending forward, the first limiting portion may be provided at a front end portion of the plate-shaped portion, and the first release portion may be provided rearward of the first limiting portion in the plate-shaped portion. For example, with such a configuration, the first limiting portion that engages with the ferrule and the first release portion that moves the first latch in the release direction can be included in the common member.
[4] In the optical connector according to any one of [1] to [3] above, a material of a member constituting the locking portion may be resin. A material of the member constituting the lever portion may be metal. Since resin is used as the material of the member constituting the locking portion, the weight of the optical connector can be reduced. In addition, by using metal as the material of the member constituting the lever portion, the strength of the lever portion can be improved.

### Details of Embodiment of Present Disclosure

A specific example of an optical connector of the present disclosure will be described below with reference to the drawings. The present invention is not limited to these examples, and is intended to include all modifications defined by the claims and within the spirit and scope of the equivalents of the claims. In the following description, the same elements in the description of the drawings are denoted by the same reference signs, and duplicate descriptions will be omitted. In each drawing, an xyz Cartesian coordinate system is shown as necessary. An x-direction corresponds to a first direction. A positive x-direction is the front, and a negative x-direction is the rear. A z-direction corresponds to a second direction.

### First Embodiment

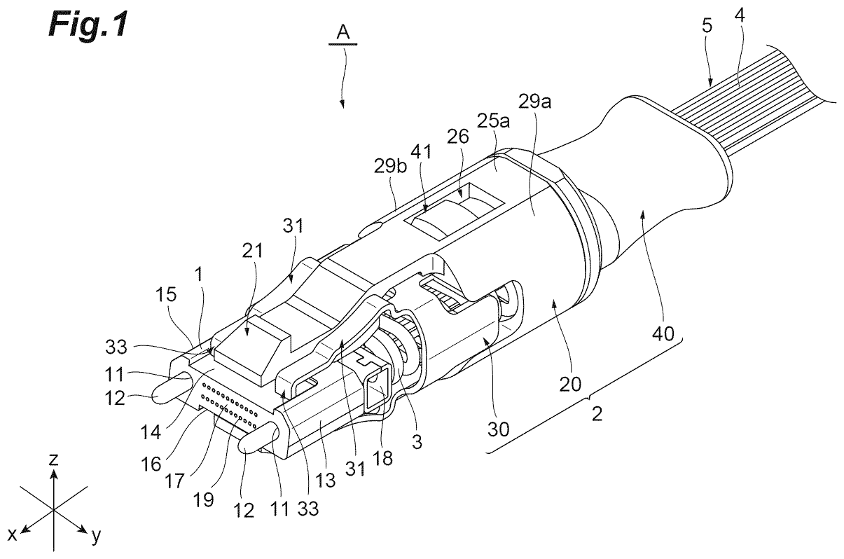

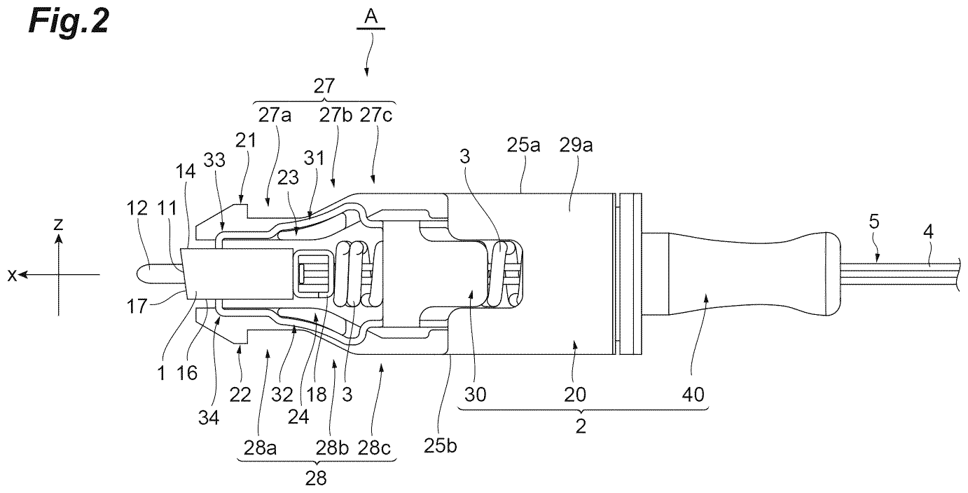

FIG. 1 is a perspective view showing an optical connector A according to a first embodiment of the present disclosure. FIG. 2 is a side view showing the optical connector A according to the first embodiment of the present disclosure. The optical connector A includes a ferrule 1, a housing 2, a coil spring 3 (elastic body), and an optical fiber group 5. The optical fiber group 5 is composed of a plurality of optical fibers 4 extending rearward along the same direction (x-direction). The ferrule 1 is a so-called MT ferrule. The ferrule 1 has a substantially rectangular parallelepiped shape. The shape of the ferrule 1 when viewed in the x-direction is a substantially rectangular shape. A plurality of fiber holes 19 into which the plurality of respective optical fibers 4 are inserted are provided inside the ferrule 1. The plurality of fiber holes 19 are formed in an array in a y-direction and the z-direction (or only in the y-direction). The fiber holes 19 hold front end portions of the respective optical fibers 4. The material of the ferrule 1 is, for example, resin.

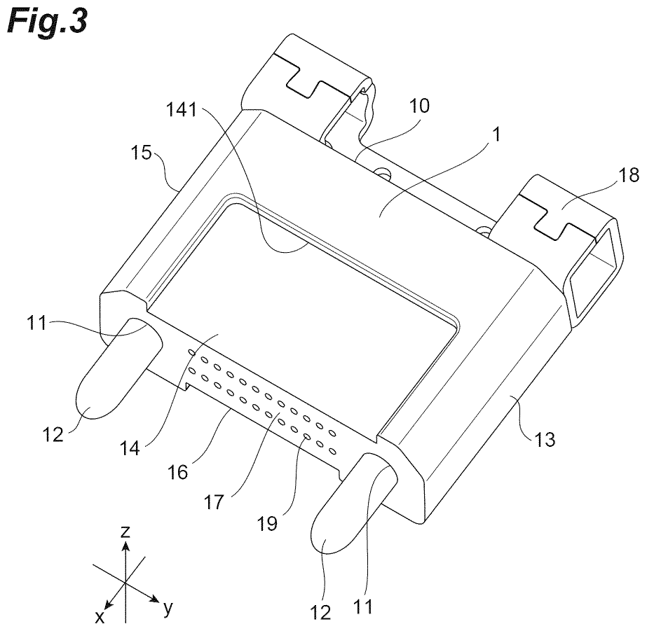

FIG. 3 is a perspective view showing the ferrule 1. The ferrule 1 has a side surface 13 (first side surface); a main surface 14 (first main surface); a side surface 15 (second side surface); a main surface 16 (second main surface); a front end surface 17; a rear end surface 10; two guide pin holes 11; two guide pins 12; and a guide pin keeper 18. The ferrule 1 has the y-direction as a width direction and the z-direction as a thickness direction. That is, a dimension of the ferrule 1 in the y-direction is greater than a dimension of the ferrule 1 in the z-direction. The side surface 13 and the side surface 15 intersect the y-direction, and extend along the z-direction and the x-direction. The side surface 13 and the side surface 15 connect the front end surface 17 and the rear end surface 10. The side surface 13 and the side surface 15 face away from each other with the plurality of fiber holes 19 interposed therebetween. The side surface 13 and the side surface 15 are flat. The main surface 14 and the main surface 16 intersect the z-direction, and extend along the x-direction and the y-direction. The main surface 14 and the main surface 16 face away from each other with the plurality of fiber holes 19 interposed therebetween. A step 141 is provided on the main surface 14. A similar step is also provided on the main surface 16.

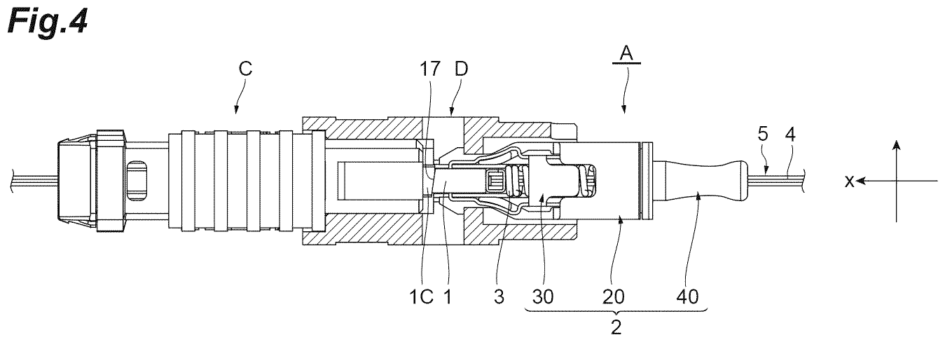

The front end surface 17 is a flat surface facing a mating ferrule 1C (see FIG. 4) in the x-direction, and intersects the x-direction. In one example, the front end surface 17 abuts against the mating ferrule 1C. The rear end surface 10 faces away from the front end surface 17, and intersects the x-direction. The two guide pin holes 11 are provided at both end portions of the front end surface 17 in the y-direction, and are aligned along the y-direction. The two guide pin holes 11 penetrate through the interior of the ferrule 1 from the front end surface 17 to the rear end surface 10 along the x-direction. The two guide pins 12 are aligned along the y-direction. The two guide pins 12 are held by the two respective guide pin holes 11, and protrude forward from the front end surface 17. The two guide pins 12 have a cylindrical shape, and extend in the x-direction. The material of the two guide pins 12 is, for example, metal.

The guide pin keeper 18 is provided at the rear of the ferrule 1, and is in contact with the rear end surface 10. The guide pin keeper 18 has a rectangular tubular shape extending in the y-direction. The material of the guide pin keeper 18 is, for example, metal. The guide pin keeper 18 holds the two guide pins 12.

FIG. 4 is a side view showing the optical connector A, an optical connector C, and an optical adapter D. The optical connector C is a connection mating optical connector, and includes the mating ferrule 1C. The optical adapter D receives the optical connector A from one end in the x-direction, and receives the optical connector C from the other end in the x-direction. The optical connectors A and C are fitted to the optical adapter D. Inside the optical adapter D, the ferrule 1 of the optical connector A faces the mating ferrule 1C of the optical connector C. In one example, the ferrule 1 abuts against the mating ferrule 1C. At this time, the two guide pins 12 are inserted into two respective guide pin holes formed in the mating ferrule 1C, so that the ferrule 1 and the mating ferrule 1C are positioned with respect to each other.

Referring again to FIGS. 1 and 2, the housing 2 includes a locking portion 20, a lever portion 30, and a grip portion 40. The housing 2 is provided on the outer periphery of the optical fiber group 5, and accommodates a portion of each of the optical fibers 4, the portion extending from the ferrule 1.

The locking portion 20 is disposed rearward of the front end surface 17 of the ferrule 1, and is provided around the ferrule 1 and the optical fiber group 5. The locking portion 20 has a shape that is plane-symmetric with respect to an imaginary plane including a center line of the optical connector A and parallel to an xy plane. A rear portion of the locking portion 20 has a substantially cylindrical shape, and a front portion of the locking portion 20 includes a plate-shaped portion 27 and a plate-shaped portion 28 that extend forward in the x-direction from the rear portion of the locking portion 20. The locking portion 20 is composed of a single member. The material of the member constituting the locking portion 20 is, for example, resin.

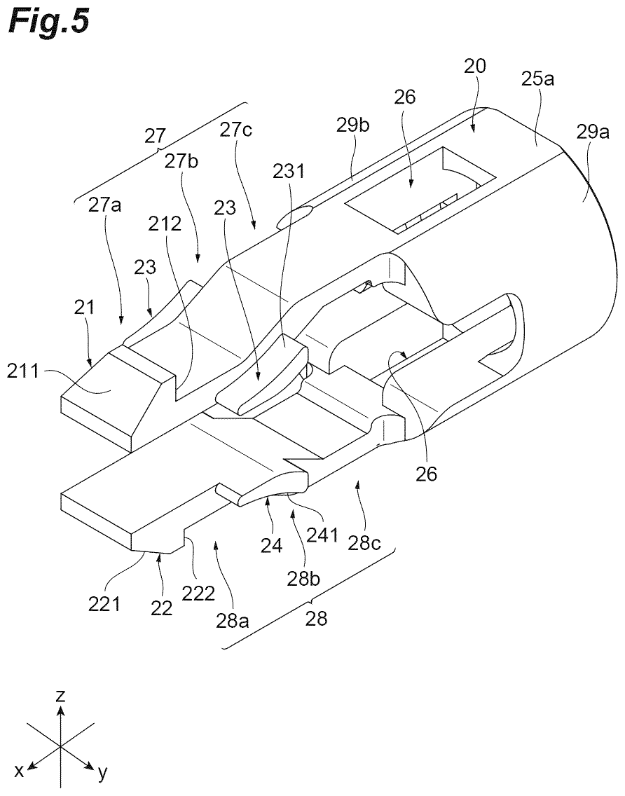

FIG. 5 is a perspective view showing the locking portion 20. The plate-shaped portion 27 includes a front portion 27a, a central portion 27b, and a rear portion 27c. The front portion 27a includes a latch 21 (the first latch). The central portion 27b includes a pair of protruding portions 23. The rear portion 27c is integrally connected to the cylindrical rear portion of the locking portion 20. The plate-shaped portion 28 includes a front portion 28a, a central portion 28b, and a rear portion 28c. The front portion 28a includes a latch 22 (the second latch). The central portion 28b includes a pair of protruding portions 24. The rear portion 28c is integrally connected to the cylindrical rear portion of the locking portion 20. The description will be made with reference to FIG. 2 in addition to FIG. 5. The front portion 27a is located on the main surface 14, and extends along the main surface 14 in the x-direction. The front portion 28a is located on the main surface 16, and extends along the main surface 16 in the x-direction. The central portion 27b and the central portion 28b are inclined with respect to the x-direction, and gradually become farther from the optical fiber group 5 as the central portion 27b and the central portion 28b extend rearward. The rear portion 27c is disposed along the optical fiber group 5, and extends in the x-direction. A spacing between the rear portion 27c and the optical fiber group 5 is greater than a spacing between the front portion 27a and the optical fiber group 5. The rear portion 28c is disposed along the optical fiber group 5, and extends in the x-direction. A spacing between the rear portion 28c and the optical fiber group 5 is greater than a spacing between the front portion 28a and the optical fiber group 5.

The latch 21 is provided on the main surface 14, and the latch 22 is provided on the main surface 16. The latch 21 and the latch 22 have inclined surfaces 211 and 221, respectively, that are inclined with respect to an xy plane. The inclined surfaces 211 and 221 become farther from the ferrule 1 as the inclined surfaces 211 and 221 extend rearward. The latch 21 and the latch 22 have abutment surfaces 212 and 222, respectively, that are perpendicular to the x-direction and that are located rearward of the inclined surfaces 211 and 221. When the optical connector A is inserted into the optical adapter D, the inclined surfaces 211 and 221 abut the optical adapter D, and the latches 21 and 22 are pressed down. Thereafter, the latches 21 and 22 return to the original positions due to the elasticity of the plate-shaped portions 27 and 28, and the abutment surfaces 212 and 222 lock onto the optical adapter D. In this way, the optical connector A is fixed to the optical adapter D.

The pair of protruding portions 23 protrude from the central portion 27b in respective positive and negative y-directions. In other words, the pair of protruding portions 23 are provided on one side and the other side of the central portion 27b in the y-direction, respectively. The protruding portions 24 protrude from the central portion 28b in the respective positive and negative y-directions. In other words, the pair of protruding portions 24 are respectively provided on one side and the other side of the central portion 28b in the y-direction. Abutment surfaces 231 and 241 of the protruding portions 23 and the protruding portions 24 which intersect the z-direction and face outward are inclined with respect to an xy plane, and become farther from the center line of the optical connector A as the abutment surfaces 231 and 241 extend rearward. The cross-sections of the abutment surfaces 231 and 241 taken along an xz plane may be curved to protrude toward the inside of the locking portion 20.

The locking portion 20 includes a surface 25a, a surface 25b, a curved surface 29a, and a curved surface 29b at the rear portion. The surface 25a and the surface 25b are surfaces intersecting the z-direction, and are flat. The curved surface 29a and the curved surface 29b are surfaces intersecting the y-direction. When viewed in the x-direction, the curved surface 29a and the curved surface 29b are curved to protrude toward the outside of the locking portion 20. Openings 26 having a rectangular shape when viewed in the z-direction are provided on the surface 25a and the surface 25b.

Referring again to FIGS. 1 and 2, the coil spring 3 is accommodated in the housing 2, and is provided around the optical fiber group 5. One end of the coil spring 3 is in contact with the guide pin keeper 18 of the ferrule 1, and the coil spring 3 biases the ferrule 1 forward. The other end of the coil spring 3 is accommodated in the locking portion 20. The coil spring 3 is a compression coil spring that is expandable and compressible in the x-direction.

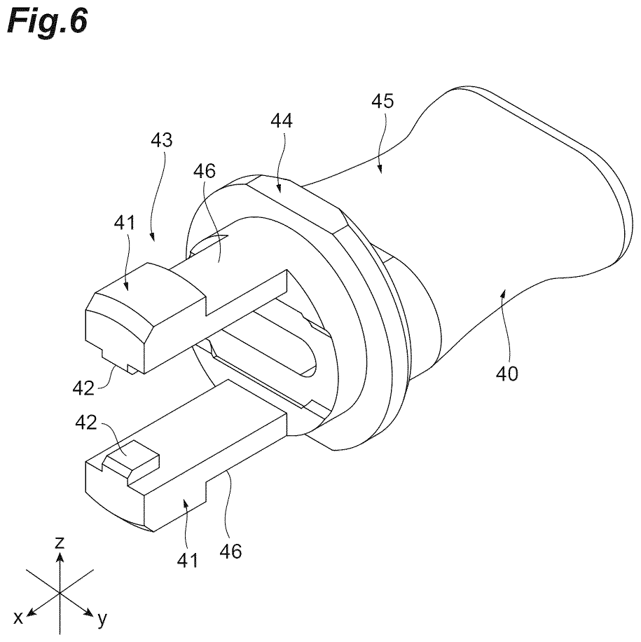

The grip portion 40 is provided rearward of the ferrule 1 and the lever portion 30, and is provided around the optical fiber group 5. In other words, the grip portion 40 is provided on the side opposite to the ferrule 1 with respect to the lever portion 30. FIG. 6 is a perspective view showing the grip portion 40. The grip portion 40 has a substantially tubular shape that is plane-symmetric with respect to an imaginary plane including the center line of the optical connector A and parallel to an xy plane. The shape of the grip portion 40 when viewed in the x-direction is a substantially circular shape. The grip portion 40 is gripped by the fingers of a person. The grip portion 40 includes a front portion 43, a central portion 44, and a rear portion 45. The central portion 44 has a disk shape. The central portion 44 is flush with the surface 25a, the surface 25b, the curved surface 29a, and the curved surface 29b of the locking portion 20 (all shown in FIG. 5). The rear portion 45 has a tubular shape with a substantially oval cross-section, and extends in the x-direction. The cross-section of the rear portion 45 perpendicular to the x-direction has an oval shape in which the length in the z-direction is shorter than the length in the y-direction. The front portion 43 includes two plate-shaped portions 46 extending from the central portion 44 in the x-direction. Each of the plate-shaped portions 46 includes a connecting portion 41 and a protrusion 42. The connecting portion 41 is provided on the outer side of a front end of the plate-shaped portion 46, and protrudes outward from the plate-shaped portion 46. The connecting portion 41 has a substantially rectangular parallelepiped shape. The connecting portion 41 is contained in the opening 26 (see FIG. 5) of the locking portion 20, and is movable in the x-direction. In other words, the connecting portion 41 is guided by the opening 26, so that the grip portion 40 is movable rearward relative to the locking portion 20. The protrusion 42 is provided on the inner side of the plate-shaped portion 46, and protrudes toward the inside of the plate-shaped portion 46. The protrusion 42 has a substantially rectangular parallelepiped shape.

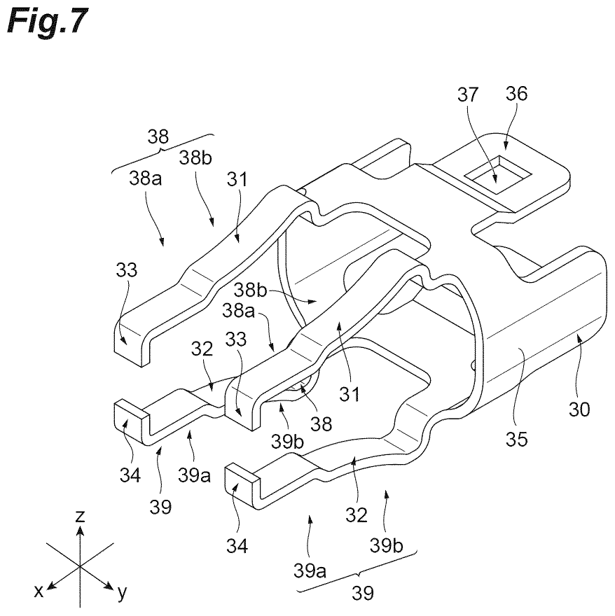

The lever portion 30 is provided around the ferrule 1 and the optical fiber group 5. FIG. 7 is a perspective view showing the lever portion 30. The lever portion 30 has a shape that is plane-symmetric with respect to an imaginary plane including the center line of the optical connector A and parallel to an xy plane. A rear portion of the lever portion 30 has a substantially cylindrical shape, and a front portion of the lever portion 30 includes two plate-shaped portions 38 and two plate-shaped portions 39. The lever portion 30 is composed of a single member 35. The material of the member 35 constituting the lever portion 30 is, for example, metal. The lever portion 30 is not fixed to the locking portion 20, and is movable rearward relative to the locking portion 20.

The two plate-shaped portions 38 and the two plate-shaped portions 39 protrude from the rear portion of the lever portion 30 in the x-direction. One plate-shaped portion 38 and one plate-shaped portion 39 are provided side by side in the z-direction. Similarly, the other plate-shaped portion 38 and the other plate-shaped portion 39 are provided side by side in the z-direction. The two plate-shaped portions 38 are provided side by side in the y-direction. The two plate-shaped portions 39 are provided side by side in the y-direction. Each of the two plate-shaped portions 38 includes a front portion 38a and a rear portion 38b. The front portion 38a includes a limiting portion 33 (first limiting portion). The rear portion 38b includes a release portion 31 (first release portion). Each of the two plate-shaped portions 39 includes a front portion 39a and a rear portion 39b. The front portion 39a includes a limiting portion 34 (second limiting portion). The rear portion 39 b includes a release portion 32 (second release portion). The release portion 31 of the one plate-shaped portion 38 and the release portion 31 of the other plate-shaped portion 38 are aligned in the y-direction. The release portion 32 of the one plate-shaped portion 39 and the release portion 32 of the other plate-shaped portion 39 are arranged in the y-direction. The release portion 31 of the one plate-shaped portion 38 and the release portion 32 of the one plate-shaped portion 39 are aligned to face each other in the z-direction. The release portion 31 of the other plate-shaped portion 38 and the release portion 32 of the other plate-shaped portion 39 are arranged to face each other in the z-direction. The surfaces of the release portion 31 and the release portion 32 which intersect the z-direction are inclined with respect to an xy plane, and become farther from an imaginary plane including the center line of the optical connector A and parallel to an xy plane as the surfaces extend rearward. The cross-sections of the release portion 31 and the release portion 32 perpendicular to the y-direction may be curved to protrude toward the inside of the lever portion 30. A lower surface of each of the release portions 31 comes into contact with the abutment surface 231 (see FIG. 5) of the corresponding protruding portion 23. An upper surface of each of the release portions 32 comes into contact with the abutment surface 241 (see FIG. 5) of the corresponding protruding portion 24.

The limiting portion 33 of the one plate-shaped portion 38 and the limiting portion 33 of the other plate-shaped portion 38 are aligned in the y-direction. The limiting portion 34 of the one plate-shaped portion 39 and the limiting portion 34 of the other plate-shaped portion 39 are aligned in the y-direction. The limiting portion 33 of the one plate-shaped portion 38 and the limiting portion 34 of the one plate-shaped portion 39 are aligned in the z-direction. The limiting portion 33 of the other plate-shaped portion 38 and the limiting portion 34 of the other plate-shaped portion 39 are aligned in the z-direction. The limiting portions 33 and 34 are provided at front end portions of the plate-shaped portions 38 and 39, respectively, protrude toward the ferrule 1, and intersect the x-direction. The limiting portion 33 engages with the step 141 (see FIG. 3) of the main surface 14 to limit the movement of the ferrule 1 based on the biasing force of the coil spring 3. The limiting portion 34 engages with the step of the main surface 16 to limit the movement of the ferrule 1 based on the biasing force of the coil spring 3.

The release portion 31 and the limiting portion 33 are aligned in the x-direction, and the release portion 31 is provided rearward of the limiting portion 33. The release portion 32 and the limiting portion 34 are aligned in the x-direction, and the release portion 32 is provided rearward of the limiting portion 34. As described above, the lever portion 30 is composed of the single member 35. Therefore, the member constituting the release portion 31 and the member constituting the limiting portion 33 are the common member 35. Similarly, the member constituting the release portion 32 and the member constituting the limiting portion 34 are the common member 35.

The lever portion 30 includes a pair of upper and lower to-be-connected portions 36. The to-be-connected portions 36 are provided at the rear portion of the lever portion 30. Each of the to-be-connected portions 36 has a substantially rectangular shape when viewed in the z-direction, and includes an opening 37 therein which has a rectangular shape when viewed in the z-direction. The protrusion 42 (see FIG. 6) of the grip portion 40 engages with the opening 37, so that the lever portion 30 and the grip portion 40 are connected to each other.

The operation of the optical connector A having the above-described configuration and effects obtained by the optical connector A will be described. When the optical connector A is inserted into the optical adapter D, the latch 21 and the latch 22 provided in the locking portion 20 lock onto the optical adapter D, so that the optical connector A is fixed to the optical adapter D. When the optical connector A is removed from the optical adapter D, the grip portion 40 gripped by the fingers of an operator is moved rearward relative to the locking portion 20 by the hand of the worker. At this time, the connecting portion 41 of the grip portion 40 is guided rearward by the opening 26 of the locking portion 20. Since the protrusion 42 of the grip portion 40 is engaged with the opening 37 of the lever portion 30, the rearward movement of the grip portion 40 is transmitted to the lever portion 30, and the lever portion 30 also moves rearward. At this time, the release portion 31 of the lever portion 30 moves rearward while coming into contact with the abutment surface 231 of the protruding portion 23, and applies a pressing force to the protruding portion 23 in a negative direction of a z-axis. Accordingly, the latch 21 moves in a release direction in conjunction with the rearward movement of the grip portion 40, and the locked state between the latch 21 and the optical adapter D is released. Similarly, the release portion 32 of the lever portion 30 moves rearward while coming into contact with the abutment surface 241 of the protruding portion 24, and applies a pressing force to the protruding portion 24 in a positive direction of the z-axis. Accordingly, the latch 22 moves in the release direction in conjunction with the rearward movement of the grip portion 40, and the locked state between the latch 22 and the optical adapter D is released. The locked state between the optical connector A and the optical adapter D by the latch 21 and the latch 22 is released by the above-described operation. According to the present embodiment, the fixation between the optical connector A and the optical adapter D can be easily released by a small structure that does not affect the maximum width of the optical connector A. Furthermore, the optical connector A can be stably fixed to the optical adapter D by two latches, namely, the latch 21 and the latch 22 that are disposed with the plurality of optical fibers 4 interposed therebetween.

Other effects obtained by the optical connector A having the above-described configuration will be described. In the optical connector A, the limiting portion 33 and the release portion 31 are provided in the lever portion 30, and are formed from the common member 35. That is, the lever portion 30 serves as the mechanism for both the limiting portion 33 and the release portion 31. Accordingly, the limiting portion 33 and the release portion 31 can be miniaturized, so that the limiting portion 33 and the release portion 31 can be provided on the main surface 14 of the ferrule 1 in a limited manner. Then, in addition to the limiting portion 33 and the release portion 31, the latch 21 is also provided on the main surface 14. The fact that the limiting portion 33, the release portion 31, and the latch 21 are provided on the main surface 14 means that the limiting portion 33, the release portion 31, and the latch 21 are disposed in a direction (z-direction) that is not a maximum width direction of the ferrule 1. In a typical optical connector, at least a part of each of the side surfaces 13 and 15 of the ferrule 1 in the y-direction is covered by the housing. Therefore, portions of the housing that cover the side surfaces 13 and 15 define a maximum width of the optical connector, and the maximum width of the optical connector is greater than a maximum width of the ferrule 1. In contrast, in the optical connector A of the present embodiment, since the limiting portion 33, the release portion 31, and the latch 21 are provided on the main surface 14 of the ferrule 1 in a limited manner, the expansion of the housing 2 in the maximum width direction (y-direction) of the ferrule 1 can be suppressed, and the width of the optical connector A can be reduced. Therefore, the optical connector A can be miniaturized.

In the optical connector A, the limiting portion 34 and the release portion 32 are provided in the lever portion 30, and are formed from the common member 35. That is, the lever portion 30 serves as the mechanism for both the limiting portion 34 and the release portion 32. Accordingly, the limiting portion 34 and the release portion 32 can be miniaturized, so that the limiting portion 34 and the release portion 32 can be provided on the main surface 16 of the ferrule 1 in a limited manner. Then, in addition to the limiting portion 34 and the release portion 32, the latch 22 is also provided on the main surface 16. The limiting portion 34, the release portion 32, and the latch 22 are provided on the main surface 16 of the ferrule 1 in a limited manner, the expansion of the housing 2 in the maximum width direction (y-direction) of the ferrule 1 can be suppressed, and the width of the optical connector A can be reduced. Therefore, the optical connector A can be miniaturized.

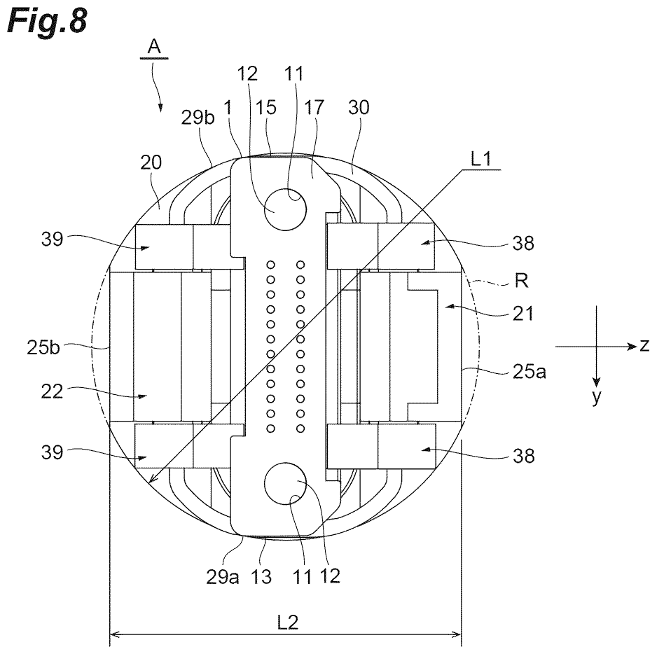

FIG. 8 is a front view of the optical connector A when viewed in the x-direction. In the optical connector A of the present embodiment, when viewed in the x-direction, the members constituting the housing 2 are contained within a circumscribed circle R of the ferrule 1. A diameter L1 of the circumscribed circle R is, for example, 5.4 mm or more and 7.8 mm or less, and in one example, the diameter L1 is 6.5 mm. A distance L2 between the surface 25a and the surface 25b, that is, the maximum width of the optical connector A in the z-direction is, for example, 4.6 mm or more and 7.8 mm or less, and in one example, the distance L2 is 5.9 mm.

In this way, when viewed in the x-direction, the members constituting the housing 2 may be contained within the circumscribed circle R of the ferrule 1. In this case, the width of the optical connector A in any direction in a plane perpendicular to the x-direction is equal to or less than the maximum width of the ferrule 1. Therefore, the optical connector A can be easily accommodated in a protective tube having a cylindrical shape.

As in the present embodiment, the material of the member constituting the locking portion 20 may be resin. The material of the member 35 constituting the lever portion 30 may be metal. Since resin is used as the material of the member constituting the locking portion 20, the weight of the optical connector A can be reduced. In addition, by using metal as the material of the member 35 constituting the lever portion 30, the strength of the lever portion 30 can be improved.

As in the present embodiment, the lever portion 30 may include the plate-shaped portion 38 extending forward, the limiting portion 33 may be provided at the front end portion of the plate-shaped portion 38, and the release portion 31 may be provided rearward of the limiting portion 33 in the plate-shaped portion 38. For example, with such a configuration, the limiting portion 33 that engages with the ferrule 1 and the release portion 31 that moves the latch 21 in the release direction can be included in the common member 35. Similarly, the lever portion 30 may include the plate-shaped portion 39 extending forward, the limiting portion 34 may be provided at the front end portion of the plate-shaped portion 39, and the release portion 32 may be provided rearward of the limiting portion 34 in the plate-shaped portion 39. For example, with such a configuration, the limiting portion 34 that engages with the ferrule 1 and the release portion 32 that moves the latch 22 in the release direction can be included in the common member 35.

### First Modification

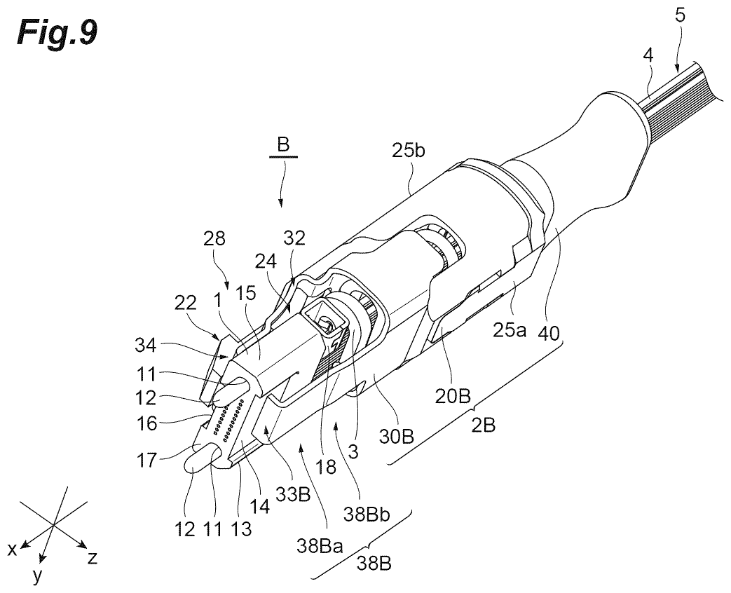

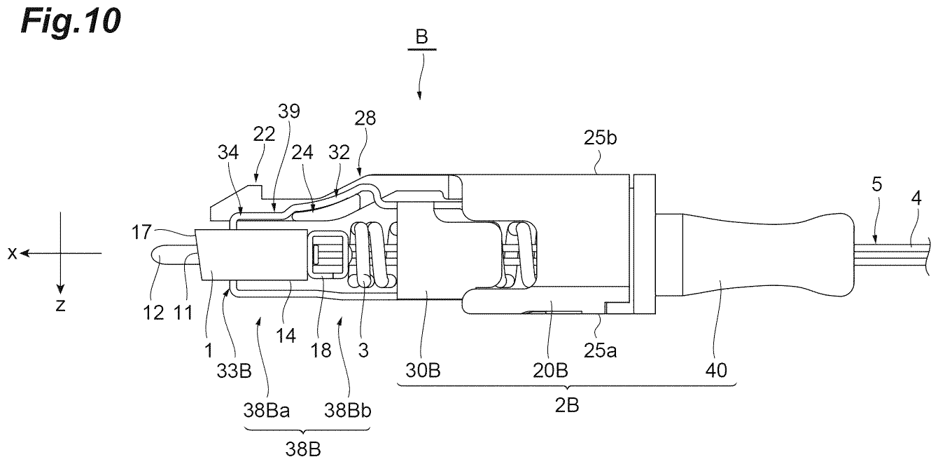

FIG. 9 is a perspective view showing an optical connector B according to a first modification. FIG. 10 is a side view showing the optical connector B according to the first modification. The optical connector B differs from the optical connector A in the following points, but is the same in the other points. The optical connector B includes a housing 2B instead of the housing 2. The housing 2B includes a locking portion 20B instead of the locking portion 20, and includes a lever portion 30B instead of the lever portion 30. The remaining structure of the housing 2B is the same as that of the housing 2.

The locking portion 20B is disposed rearward of the front end surface 17 of the ferrule 1, and is provided around the ferrule 1 and the optical fiber group 5. The locking portion 20B has a substantially tubular shape. A front portion of the locking portion 20B includes a plate-shaped portion 28 that extends from the rear portion of the locking portion 20B in the x-direction and includes the latch 22. The locking portion 20B does not include the plate-shaped portion 27 (see FIG. 5) including the latch 21. The locking portion 20B is composed of a single member. The material of the member constituting the locking portion 20B is, for example, resin.

The lever portion 30B is provided around the ferrule 1 and the optical fiber group 5. The lever portion 30B includes one plate-shaped portion 38B instead of the two plate-shaped portions 38. The lever portion 30B is composed of the single member 35. The material of the member 35 constituting the lever portion 30B is, for example, metal. The lever portion 30B is movable rearward relative to the locking portion 20B.

The plate-shaped portion 38B is provided at a front portion of the lever portion 30B, and extends from a rear portion of the lever portion 30B in the x-direction. The plate-shaped portion 38B is provided on the main surface 14 of the ferrule 1, and faces the two plate-shaped portions 39 with the ferrule 1 interposed therebetween. The plate-shaped portion 38B includes a front portion 38Ba and a rear portion 38Bb. The front portion 38Ba includes a limiting portion 33B instead of the limiting portion 33. The rear portion 38Bb does not include the release portion 31. The limiting portion 33B protrudes toward the ferrule 1, and intersects the x-direction. The limiting portion 33B engages with the step 141 (see FIG. 3) of the main surface 14 to limit the movement of the ferrule 1 based on the biasing force of the coil spring 3.

When the optical connector B having the above-described configuration is inserted into the optical adapter D, the latch 22 provided in the locking portion 20 locks onto the optical adapter D, so that the optical connector B is fixed to the optical adapter D. When the optical connector B is removed from the optical adapter D, the grip portion 40 gripped by the fingers of an operator is moved rearward relative to the locking portion 20B by the hand of the worker. At this time, the connecting portion 41 of the grip portion 40 is guided rearward by the opening 26 of the locking portion 20B. Since the protrusion 42 of the grip portion 40 is engaged with the opening 37 of the lever portion 30B, the rearward movement of the grip portion 40 is transmitted to the lever portion 30B, and the lever portion 30B also moves rearward. At this time, the release portion 32 of the lever portion 30B moves rearward while coming into contact with the abutment surface 241 of the protruding portion 24, and applies a pressing force to the protruding portion 24 along the z-direction. Accordingly, the latch 22 moves in the release direction in conjunction with the rearward movement of the grip portion 40, and the locked state between the latch 22 and the optical adapter D is released. The locked state between the optical connector B and the optical adapter D by the latch 22 is released by the above-described operation. According to the present embodiment, the fixation between the optical connector B and the optical adapter D can be released by a small structure that does not affect the maximum width of the optical connector B.

In the present modification as well, the width of the optical connector B can be reduced, and the optical connector B can be miniaturized.

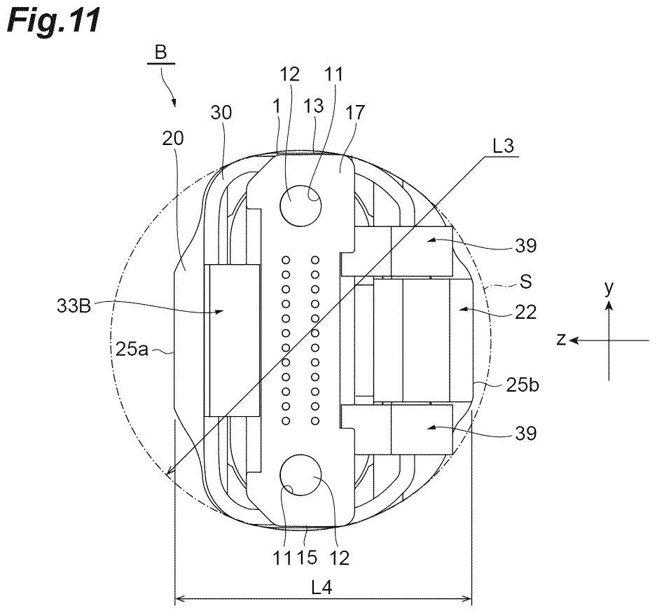

FIG. 11 is a front view of the optical connector B when viewed in the x-direction. In the optical connector B of the present modification as well, when viewed in the x-direction, the components constituting the housing 2B are contained within a circumscribed circle S of the ferrule 1. A diameter L3 of the circumscribed circle S is, for example, 5.4 mm or more and 7.8 mm or less, and in one example, the diameter L3 is 6.5 mm. A distance L4 between the surface 25a and the surface 25b is, for example, 2.7 mm or more and 5.7 mm or less, and in one example, the distance L4 is 5.2 mm.

The embodiments and the modifications of the present invention have been described above; however, the present invention is not limited to the embodiments and the modifications described above, and can be modified without departing from the spirit and scope of the present invention. For example, in the embodiment and the modification described above, an example in which the grip portion 40 has a cylindrical shape has been shown; however, the grip portion 40 may have other shapes such as a rectangular tubular shape.

### REFERENCE SIGNS LIST

1: ferrule, 1C: mating ferrule, 2, 2B: housing, 3: coil spring, 4: optical fiber, 5: optical fiber group, 10: rear end surface, 11: guide pin hole, 12: guide pin, 13, 15: side surface, 14, 16: main surface, 25a, 25b: surface, 17: front end surface, 18: guide pin keeper, 19: fiber hole, 20, 20B: locking portion, 21, 22: latch, 23, 24: protruding portion, 26, 37: opening, 27, 28, 38, 38B, 39: plate-shaped portion, 27a, 28a, 38a, 38Ba, 39a, 43: front portion, 27b, 28b, 44: central portion, 27c, 28c, 38b, 38Bb, 39b, 45: rear portion, 29a, 29b: curved surface, 30, 30B: lever portion, 31, 32: release portion, 33, 33B, 34: limiting portion, 35: member, 36: to-be-connected portion, 40: grip portion, 41: connecting portion, 42: protrusion, 46: plate-shaped portion, 141: step, 211, 221: inclined surface, 212, 222: abutment surface, A to C: optical connector, D: optical adapter, L1, L3: diameter, L2, L4: distance, R, S: circumscribed circle.

1. An optical connector, comprising:
a plurality of optical fibers extending rearward along a first direction;
a ferrule that holds front end portions of the plurality of optical fibers;
a housing that is provided on an outer periphery of the plurality of optical fibers and that accommodates portions of the plurality of optical fibers, the portions extending from the ferrule; and
an elastic body that biases the ferrule forward along the first direction and that is accommodated in the housing,
wherein the ferrule has a front end surface facing a mating ferrule, a rear end surface facing away from the front end surface, and a first main surface and a second main surface that intersect a second direction, which is a thickness direction of the ferrule, while facing away from each other with the plurality of optical fibers interposed between the first main surface and the second main surface, and that connect the front end surface and the rear end surface,
the housing includes a locking portion including a first latch that locks onto an optical adapter to fix the optical connector to the optical adapter, a lever portion that includes a first release portion that releases locking of the first latch and a first limiting portion that engages with the ferrule on the first main surface to limit a movement of the ferrule based on a biasing force of the elastic body, and that is movable rearward relative to the locking portion, and a grip portion that is provided at a rear of the ferrule and that is connected to the lever portion to be movable rearward relative to the locking portion,
the first latch is provided on the first main surface,
the first release portion moves the first latch in a release direction in conjunction with rearward movement of the grip portion, and
a member constituting the first release portion is common to a member constituting the first limiting portion.

2. The optical connector according to claim 1,
wherein the locking portion further includes a second latch that locks onto the optical adapter to fix the optical connector to the optical adapter,
the second latch is provided on the second main surface,
the lever portion further includes a second release portion that moves the second latch in a release direction in conjunction with rearward movement of the grip portion to release locking of the second latch, and a second limiting portion that engages with the ferrule on the second main surface to limit the movement of the ferrule based on the biasing force of the elastic body, and
a member constituting the second release portion is common to a member constituting the second limiting portion.

3. The optical connector according to claim 1,
wherein the lever portion includes a plate-shaped portion extending forward,
the first limiting portion is provided at a front end portion of the plate-shaped portion, and
the first release portion is provided rearward of the first limiting portion in the plate-shaped portion.

4. The optical connector according to claim 1,
wherein a material of a member constituting the locking portion is resin, and
a material of the member constituting the lever portion is metal.

5. The optical connector according to claim 2,
wherein a material of a member constituting the locking portion is resin, and
a material of the member constituting the lever portion is metal.

6. The optical connector according to claim 3,
wherein a material of a member constituting the locking portion is resin, and
a material of the member constituting the lever portion is metal.
